(19) United States
(12) Patent Application Publication
(10) Pub. No.: US 2004/0176951 A1
(43) Pub. Date: Sep. 9, 2004

(54) LSF coefficient vector quantizer for wideband speech coding

(76) Inventors: Ho Sang Sung, Daejeon-city (KR); Dae Hwan Hwang, Daejeon-city (KR); Sang Won Kang, Ansan-city (KR); Kang Eun Lee, Ansan-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/749,745

(22) Filed: Dec. 30, 2003

(30) Foreign Application Priority Data
Mar. 5, 2003 (KR) 2003-13606

(51) Int. Cl. G10L 19/12

(52) U.S. Cl. 704/222

(57) ABSTRACT

A line spectral frequency (LSF) coefficient vector quantizer greatly affects wideband speech coding efficiency and performance. An LSF coefficient quantizer of an existing speech codec can be modified into a new structure in which a non-structural vector quantizer and a lattice quantizer are connected in series. Thus, memory capacity and search time required for the LSF coefficient quantizer can be reduced. In addition, a prediction structure and a non-prediction structure can be connected in parallel to stably perform quantization and reduce a quantization transfer error. As a result, an efficient LSF quantizer capable of reducing allocated bits and improving SD can be provided. Moreover, non-structural vector quantization can be performed prior to pyramid vector quantization to convert an input value into a Laplacian model suitable for a pyramid vector quantizer. Also, a high-performance quantizer can be provided by determining a joint optimisation vector between two serial quantizers using a small amount of computation of the pyramid vector quantizer. Furthermore, outliers unsuitable for the prediction structure can be correctly quantized by adopting the prediction structure and the non-prediction structure.

### BACKGROUND OF THE INVENTION

This application claims the priority of Korean Patent Application No. 2003-13606, filed on Mar. 5, 2002, in the Korean Intellectual Property Office, the disclosure of which is incorporated herein in its entirety by reference.

1. Field of the Invention

The present invention relates to speech coding, and more particularly, to a line spectral frequency (LSF) coefficient vector quantizer which greatly affects wideband speech coding efficiency and performance.

2. Description of the Related Art

As the digital age emerges, almost all communication systems transmit and receive a signal in a digital way not in an analog way. In addition, further advanced digital processing techniques have appeared. In order to efficiently transmit and receive image and speech signals, it is necessary to reduce load on a transceiver during the transmission and receipt of the image and speech signals. In order to decode the image and speech signals as high-quality analog signals in a receiver, it is necessary to code the image and speech signals at high quality and efficiency. Accordingly, the digital processing techniques lay great weight on a way to compress image and speech signals at high quality and efficiency.

Since the short term correlation of a speech signal is lower than that of an image signal, a key point of wideband speech signal coding is to reduce load on a system during transmission of the speech signal and efficiently quantize an LSF coefficient indicating the short term correlation of the speech signal so as to reproduce high-quality speech in a receiver. Therefore, the accurate calculation of the short term correlation is quite important in efficient coding of a speech signal.

Most wideband speech coding techniques analyze a spectral envelope of speech to express the speech with parameters. In order to express the spectral envelope with parameters, the linear prediction coding (LPC) parameters are used, where LPC is also called short term LPC.

Processes of coding and decoding a wideband speech signal codec are followed by quantizing the LPC parameters and then transmitting the quantized LPC parameters to a receiver in a transmitter and reconstructing the spectral envelope using the quantized LPC parameters in the receiver.

The quantization of the LPC parameters is achieved by an LPC filter, optimum linear prediction coefficient of which is first calculated. After a speech signal is divided into frames, the optimum linear prediction coefficient is obtained so as to minimize a prediction error of each of the frames.

An example of existing linear prediction filters is a linear prediction filter of an adaptive multi-rate wideband (AMR-WB) (G.722.2) speech codec which is a 16^{th}-order all-pole filter. Many bits are required to quantize linear prediction coefficients for poles. For example, IS-96A qualcomm code excited linear prediction (QCELP), which is a speech coding method used in code division multiple access (CDMA) mobile communication systems, allocates about 25% of bits necessary for coding to quantization of linear prediction coefficients. The AMR-WB speech codec allocates from a minimum of 9.6% to a maximum of 27.3% of bits necessary for coding to quantization of linear prediction coefficients.

A variety of quantization methods have bee suggested. Among these, methods of directly quantizing linear prediction coefficients are mainly adopted. However, in a case where linear prediction coefficients are directly quantized, the characteristics of the linear prediction filter are greatly affected by errors in the quantization of the linear prediction coefficients. Thus, the stability of the linear prediction filter cannot be secured after quantization.

To solve the above problem, there has been developed a technique for transforming a linear prediction coefficient into another representation and then quantizing the representation. In this technique, the linear prediction coefficient is transformed into a mathematically equivalent reflection coefficient or an LSF coefficient and then quantized. As shown from LSF, the LSF coefficient reflects the frequency property of speech. Due to this, recent quantization is achieved generally by transforming a linear prediction coefficient into an LSF coefficient.

For quantization efficiency, the LSF quantization technique uses the correlation (short term correlation) between frames. In other words, instead of directly quantizing an LSF of a current frame, the LSF quantization technique predicts the LSF of the current frame from information on an LSF of a previous frame and quantizes an error in this prediction. Auto regressive (AR) prediction or moving average (MA) prediction may be used as the prediction method. The former has a high prediction performance but has a disadvantage in that a coefficient transfer error continuously affects a receiver. The latter has a lower prediction performance than the former but has an advantage in that a coefficient transfer error limitedly affects the receiver. Accordingly, the MA prediction is used in a wireless communication environment in which many coefficient transfer errors occur.

In general, quantization of the full vector requires a voluminous code book and a great deal of time to search for a candidate vector. Thus, the full vector should be split into a plurality of sub vectors, and then the sub vectors should be independently quantized. For this, split vector quantization was suggested. However, although the SVQ is adopted for quantization, a great deal of memory and computation are still required to store the code book. Thus, split effect is slight, and the correlation between frames decreases with an increase in the number of splits, which results in a poor quantization performance.

For efficiency of vector quantization, there has been suggested another technique in which a multi-stage quantizer is used so as to quantize a quantization error occurring in a previous stage quantizer using a next stage quantizer. However, a great deal of memory and computation are still required in a wideband to which many bits are allocated.

FIG. 1 shows the configuration of a linear prediction coefficient quantizer used in a wideband speech codec with a split-multi stage vector quantization (S-MSVQ) structure according to 3^{rd} Generation Partnership Project (3GPP) standards. The linear prediction coefficient quantizer reflects the concepts of SVQ and multi-stage. The operation of the linear prediction coefficient quantizer will now described in brief.

The linear prediction coefficient quantizer subtracts a DC component LSF_DC\overline{ƒ} from a 16-dimensional LSF coefficient LSFƒ, split-vector-quantizes a 16-dimensional prediction error vector, which is an error value between the 16-dimensional LSF coefficient LSFƒ from which the DC component has bee subtracted and a vector predicted by a predictor, into a 9-dimensional sub vector dim.9 and a 7-dimensional sub vector dim.7, and split-vector-quantizes the 9-dimensional sub vector dim.9 into 3-dimensional sub vectors dim.3. and the 7-dimensional sub vector dim.7 into a 3-dimensional sub vector dim.3 and a 4-dimensional sub vector dim.4.

The S-MSVQ structure reduces a time to search for a memory and a code book required for quantization of an LSF coefficient to which 46 bits are allocated. The S-MSVQ structure also requires a smaller deal of computation to search for a memory and a code book than when quantizing the full vector. However, as described above, the S-MSVQ structure still requires a large amount of computation due to a large amount of memory (2⁸×9+2⁸×7+2⁶×3+2⁷×3+2⁷×3+2⁵×3+2⁵×4) and the complexity of a search for a code book.

A vector quantizer is roughly classified into a non-structural quantizer (non-lattice quantizer) and a lattice quantizer. The non-structural quantizer stores a code book, while the lattice quantizer stores only an index of the code book. Thus, the lattice quantizer is superior to the non-structural quanitzer in terms of memory capacity for the code book.

The lattice quantizer is classified into a uniform lattice quantizer and a pseudo uniform lattice quantizer or into a spherical lattice quantizer and a pyramid vector quantizer (PVQ). The PVQ is mainly used due to quantization quality, efficiency, and so forth.

Such a PVQ is disclosed in a paper by Thomas R. Fischer, entitled “A Pyramid Vector Quantizer”, IEEE Transactions on Information Theory Vol.IT-32, pp568-583, 4. Jul. 1986.

Since the PVQ quantizes lattice points on an L-dimensional pyramid, the PVD does not require a memory for storing a code book and linearly increases the complexity of coding with an increase in vector dimension. Thus, the PVQ can quantize the full vector with a small amount of computation. In particular, in a case where the dimension of an input vector is large, for Laplacian sources, the PVQ shows an almost equivalent performance to an entropy limit scalar quantizer.

When a vector input to a quantizer has a Laplacian distribution, optimum codewords can be designed on a single pyramid.

Coding steps of the PVQ suggested in the above paper will be described.

First step: project input codewords onto a pyramid surface and select the closest codeword.

Second step: scale the codewords projected onto the pyramid surface so that the codewords lie on a standardized pyramid.

Third step: find and select a codeword with the closest integer to the codewords on the standardized pyramid.

Fourth step: scale the codewords represented as lattice points on the pyramid surface to original size to obtain quantized vectors of input codewords.

The PVQ shows a high performance when the dimension of the input vector is sufficiently large. When the dimension of the input vector is 20 or more, norm values of sources approximate regular values. However, when the vector dimension is 20 or less, the norm values of the sources are dispersed and thus become irregular values. Therefore, many errors occur during quantization using a single pyramid. As presented in the above paper, a product code PVQ (PCPVQ) is used in order to overcome the above problems. FIG. 2 is a block diagram of the PCPVQ. The operation of the PCPVQ is described in the above paper and thus will not be explained herein.

The PCPVQ standardizes an input vector, quantizes the input vector into a single pyramid, and index the quantized pyramid using a standard element value. Thus, an effect of using the pyramid as much as the standard element can be obtained.

The PVQ is suitable to process Laplacian sources. However, in a case where during quantization using only the PVQ, the Laplacian sources have a distribution that is not supported by the lattice quantizer, quantization performance decreases. For example, in the PVQ, an input LSF vector from which a prediction value has been subtracted a Laplacian distribution, while many outliers do not exactly lie in the Laplacian distribution. As a result, quantization performance of the PVQ deteriorates.

### SUMMARY OF THE INVENTION

The present invention provides an LSF coefficient vector quantizer for wideband coding which can reduce memory capacity and computations required for quantization and prevent deterioration of quantization performance occurring when only a lattice quantizer is used.

According to an aspect of the present invention, there is provided a line spectral frequency coefficient vector quantizer including a prediction structure quantizer, a non-prediction structure quantizer, and a switch. The prediction structure quantizer includes a first vector quantizer which non-structurally quantizes a line spectral frequency coefficient vector to calculate a candidate vector to be quantized, a predictor which calculates a predicted line spectral frequency vector of the line spectral frequency coefficient vector, and a first lattice quantizer which lattice-quantizes the candidate vector with reference to the predicted line spectral frequency vector to calculate a final prediction quantization vector of the line spectral frequency coefficient vector. The non-prediction structure quantizer includes a second vector quantizer which non-structurally quantizes the line spectral frequency coefficient vector to calculate a candidate vector to be quantized and a second lattice quantizer which lattice-quantizes the candidate vector to calculate a final non-prediction quantization vector of the line spectral frequency coefficient vector. The switch determines one having a small difference from the line spectral frequency coefficient vector, from the final prediction quantization vector and the final non-prediction quantization vector, as a final quantization vector of the line spectral frequency coefficient vector.

It is preferable that the prediction structure quantizer and the non-prediction structure quantizer are connected in parallel to quantize the line spectral frequency coefficient vector. It is preferable that the first vector quantizer and the first lattice quantizer are connected in series to quantize the line spectral frequency coefficient vector. It is preferable that the second vector quantizer and the second lattice quantizer are connected in series to quantize the line spectral frequency coefficient vector. It is preferable that the first lattice quantizer is a pyramid vector quantizer. It is preferable that the second lattice quantizer is a pyramid vector quantizer.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a linear prediction coefficient quantizer used in a wideband speech codec in compliance with 3GPP standards;

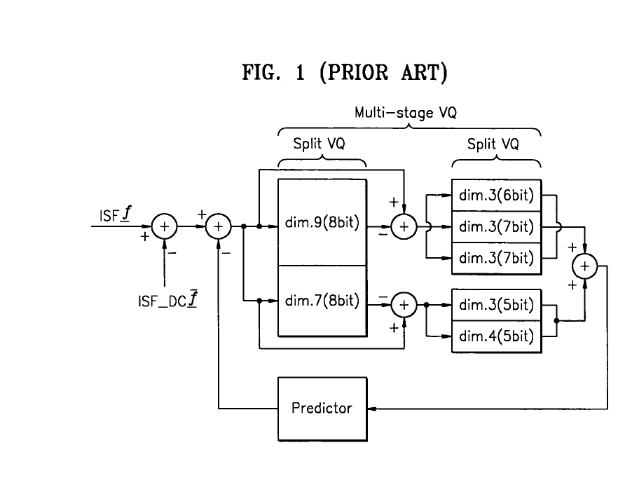

FIG. 2 is a block diagram of a PCPVQ; and

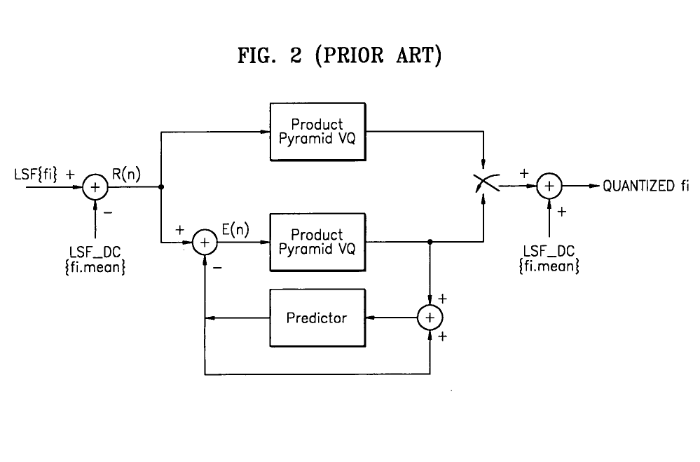

FIG. 3 is a block diagram of an optimized LSF coefficient quantizer according to the present invention.

### DETAILED DESCRIPTION OF THE INVENTION

Reference will now be made in detail to the present embodiment of the present invention, examples of which are illustrated in the accompanying drawings, wherein like reference numerals refer to the like elements throughout. The embodiment is described below in order to explain the present invention by referring to the figures.

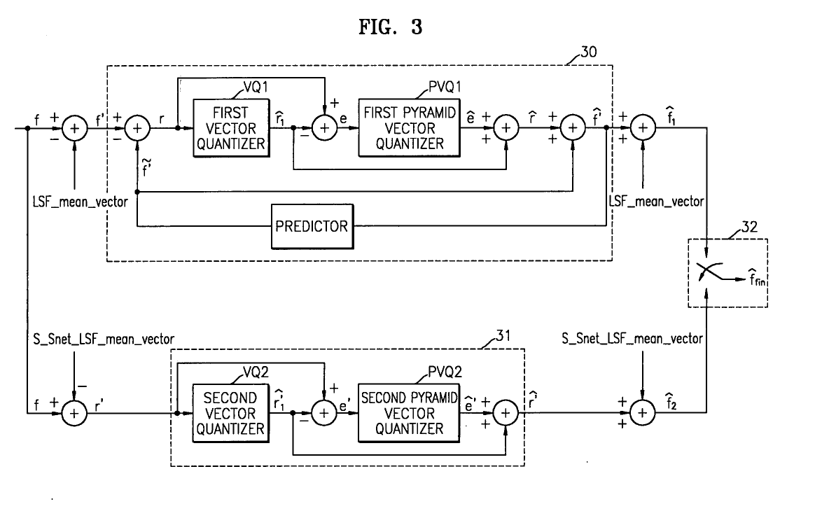

FIG. 3 shows the configuration of an optimized LSF coefficient quantizer according to the present invention. Referring to FIG. 3, the LSF coefficient quantizer has a safety-net structure in which a prediction structure 30 and a non-prediction structure 31 are connected in parallel to quantize an LSF coefficient vector f simultaneously into vectors \hat{ƒ}₁ and \hat{ƒ}₂ in prediction and non-prediction ways and select one of the vectors \hat{ƒ}₁ and \hat{ƒ}₂ as a final quantization vector \hat{ƒ}_{fin} of the LSF coefficient vector f. The prediction and non-prediction structures 30 and 31 form a multi-stage quantization structure in which a non-structural vector quantizer VQ1 and a pyramid vector quantizer PVQ1 are serially connected to a non-structural vector quantizer VQ2 and a pyramid vector quantizer PVQ 2, respectively.

Quantization performed in the prediction structure 30 will be first described.

A first stage quantizer, i.e., a first vector quantizer VQ1, is a non-structural vector quantizer which performs vector quantization. The first vector quantizer VQ1 selects a quantization candidate vector from a code book through the vector quantization. In other words, the first vector quantizer VQ1 subtracts a mean DC value LSF_mean_vector from an input LSF coefficient vector f to obtain an LSF vector f′, and vector-quantizes an error vector r between the LSF vector f′ and a predicted LSF vector \tilde{ƒ}′ of the LSF coefficient vector f calculated by a predictor into a quantized error vector \hat{r}₁, which is the candidate vector.

The first vector quantizer VQ1 quantizes the full error vector r so as not to reduce a short term correlation. Thus, the magnitude of the code book should be considered due to the quantization of the full error vector r. Therefore, in the present invention, less than 1/7 of a total of bits are allocated for vector quantization so as to reduce memory and search time required for a code book used in the vector quantization.

A second stage quantizer, i.e., a first pyramid vector quantizer PVQ1, is a lattice quantizer which lattice-quantizes the candidate vector with reference to the predicted LSF vector \tilde{ƒ}′ to produce a prediction quantization vector of the LSF coefficient vector f, i.e., a quantization vector \hat{ƒ}₁ of the LSF coefficient vector f in the prediction structure 30. For the production of the quantization vector \hat{ƒ}₁ of the LSF coefficient vector f, a difference vector e between the error vector r and the quantized error vector \hat{r}₁, is quantized.

A pyramid vector quantizer using a single pyramid shows a high performance when a dimension of an input vector is sufficiently large, i.e., 20 or more. However, in a case where a wideband speech codec does not receive an input vector with a dimension of more than 20, the dispersion of a norm of a vector indicating the magnitude of a pyramid increases, which increases a quantization error. The PCPVQ was suggested in the above paper so as to solve these problems. Since the wideband speech codec receives a 16-dimensional linear prediction coefficient, the present invention may use a PCPVQ as the first pyramid vector quantizer PVQ1. A second pyramid vector quantizer PVQ2, which will be described below, may also be a PCPVQ.

The PCPVQ standardizes an input vector, quantizes the input vector into a single pyramid, and represent the magnitude of the quantized pyramid using a standard element value. As a result, an effect of quantizing an input vector into a pyramid as much as the standard element value not into the single pyramid can be achieved.

The first pyramid vector quantizer PVQ1 receives 16 difference vectors e and pyramid-vector-quantizes each of the 16 difference vectors e. An amount of computation required for the pryramid-vector-quantization is not much problematic since the first pyramid vector quantizer PVQ1 requires a quite small amount of computation. Accordingly, a joint optimisation vector between the first vector quantizer VQ1 and the first pyramid vector quantizer PVQ1 should be determined so as to perform high-performance quantization.

The operation of the prediction structure 30 of the present invention will be explained in more detail.

The LSF coefficient vector f is input to each of the prediction structure 30 and the non-prediction structure 31. A mean LSF value LSF_mean_vector, i.e., the DC value, is subtracted from the LSF coefficient vector f to obtain the LSF vector f′ using Equation 1 below. This is a process of expressing the LSF coefficient vector f as an i^{th} codeword of the code book.

ƒ′=ƒ−LSF_mean_vector (1)

The error vector r between the LSF vector f′ and the predicted LSF vector \hat{ƒ}′ of the LSF coefficient vector f calculated by the predictor is obtained using Equation 2:

r=ƒ′−\hat{ƒ}′ (2)

wherein r denotes the error vector obtained from subtraction of the predicted LSF vector \tilde{ƒ}′ from the LSF vector f′ from which the mean LSF value LSF_mean_vector is subtracted.

The first vector quantizer VQ1 produces the quantized error vector \hat{r}₁, by quantizing the error vector r which is the above-mentioned candidate vector. The quantized error vector \hat{r}₁, is converted into the difference vector e so as to approximate Laplacian distribution optimum to pyramid vector quantization performed by the second stage quantizer, i.e., the first pyramid vector quantizer PVQ1. The difference vector e is obtained using Equation 3;

e=r−\hat{r}₁ (3)

wherein e denotes the difference vector between the original error vector r and the vector-quantized error vector \hat{r}₁, of the original error vector r, where the difference vector e approximates Laplacian distribution.

The first pyramid vector quantizer PVQ1 pyramid-vector-quantizes the difference vector e into a difference vector ê. The difference vector ê is added to the candidate vector \hat{r}₁ to obtain a final quantization vector \hat{r} of the error vector r. The quantization vector \hat{ƒ}′ of the predicted LSF vector f′ is calculated by adding the final quantization vector \hat{r} to the quantization vector \hat{ƒ}′ (?). A final quantization vector \hat{ƒ}₁ of the LSF coefficient vector f is calculated by adding the mean LSF value LSF_mean_vector to the quantization vector \hat{ƒ}′.

During quantization performed in the non-prediction structure 31, a prediction operation is not carried out. A mean LSF value s_snet_LSF_mean_vector, i.e., a DC value, is subtracted from the LSF vector f to obtain an LSF vector r′. Next, the LSF vector r′ is quantized to obtain a quantized vector \hat{r}₁′ via a second vector quantizer VQ2 and a second pyramid vector quantizer PVQ2 in the same way as in the prediction structure 30. Thereafter, the mean LSF value s_snet_LSF_mean_vector is added to the quantized vector \hat{r}₁′ to obtain a final quantization vector \hat{ƒ}₂ of the LSF coefficient vector f in the non-prediction structure 31. Here, the second vector quantizer VQ2 and the second pyramid vector quantizer PVQ2 correspond to the first vector quantizer VQ1 and the first pyramid vector quantizer PVQ1 of the prediction structure 30, respectively. Also, \hat{r}₁′,e′, and ê′ correspond to the vector-quantized error vector \hat{r}₁, the difference vector e, and the difference vector ê of the prediction structure 30, respectively.

A switch 32 selects one from the predicted quantization vector \hat{ƒ}₁ and non-predicted quantization vector \hat{ƒ}₂ to determine a final quantization vector \hat{ƒ}_{fin} of the LSF coefficient vector f. In other words, of the predicted quantization vector \hat{ƒ}₁ and non-predicted quantization vector \hat{ƒ}₂, one having a small difference from the LSF coefficient vector f is determined as the final quantization vector \hat{ƒ}_{fin}.

Tables 1 through 3 each show performances, amounts of computation, and memory capacities for storing a code book with respect to split and multi-stage vector quantization (S-MSVQ) used in an AMR-WB LPC quantizer, pyramid vector quantization (PVQ), and quantization of the present invention, respectively. The amounts of computation were measured using weighted million operation per second (WMOPS), the performances were measured using spectral distortion (SD), and the memory capacities were measured using words.

As can be seen in Table 1, the SD of the present invention increases by about 0.1 dB compared to the SD of the AMR-WB S-MSVQ. Outliers of the present invention between 3 dB and 5 dB decrease by 0.001% compared to outliers of the AMR-WB S-MSVQ. Compared to the PVQ, the SD of the present invention decreases by about 0.25 dB, the outliers of the present invention between 3 dB and 5 dB decrease by about 0.2%, and outliers of the present invention above 5 dB decrease by 0.005%. As a result, the quantization structure of the present invention shows the highest performance.

As can be seen in Tables 2 and 3, the amount of computation and memory according to the present invention decrease by about 17% and about 51%, respectively, compared to the AMR-WB.

TABLE 1

| | AMR-WB S-MSVQ | PVQ | Present Invention |
|---|---|---|---|
| Mean SD[dB] | 0.842 | 0.992 | 0.745 |
| 3 dB-5 dB [%] | 0.013 | 0.220 | 0.012 |
| 5 dB or more [%] | 0 | 0.005 | 0 |

TABLE 2

| | AMR-WB S-MSVQ | PVQ | Present Invention |
|---|---|---|---|
| WMOPS | 1.6814 | 0.0709 | 1.3988 |

TABLE 3

| | AMR-WB S-MSVQ | PVQ | Present Invention |
|---|---|---|---|
| Word | 6880 | 336 | 3343 |

As described above, according to the present invention, an LSF coefficient quantizer of an existing speech codec can be modified into a new structure in which a non-structural vector quantizer and a lattice quantizer are, connected in series. Thus, memory capacity and search time required for the LSF coefficient quantizer can be reduced. In addition, a prediction structure and a non-prediction structure can be connected in parallel to stably perform quantization and reduce a quantization transfer error. As a result, an efficient LSF quantizer capable of reducing allocated bits and improving SD can be provided.

Moreover, non-structural vector quantization can be performed prior to pyramid vector quantization to convert an input value into a Laplacian model suitable for a pyramid vector quantizer. Also, a high-performance quantizer can be provided by determining a joint optimisation vector between two serial quantizers using a small amount of computation of the pyramid vector quantizer. Furthermore, outliers unsuitable for the prediction structure can be correctly quantized by adopting the prediction structure and the non-prediction structure.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A line spectral frequency coefficient vector quantizer comprising:
a prediction structure quantizer that comprises a first vector quantizer which non-structurally quantizes a line spectral frequency coefficient vector to calculate a candidate vector to be quantized, a predictor which calculates a predicted line spectral frequency vector of the line spectral frequency coefficient vector, and a first lattice quantizer which lattice-quantizes the candidate vector with reference to the predicted line spectral frequency vector to calculate a final prediction quantization vector of the line spectral frequency coefficient vector;
a non-prediction structure quantizer that comprises a second vector quantizer which non-structurally quantizes the line spectral frequency coefficient vector to calculate a candidate vector to be quantized and a second lattice quantizer which lattice-quantizes the candidate vector to calculate a final non-prediction quantization vector of the line spectral frequency coefficient vector; and
a switch that determines one having a small difference from the line spectral frequency coefficient vector, from the final prediction quantization vector and the final non-prediction quantization vector, as a final quantization vector of the line spectral frequency coefficient vector.

2. The line spectral frequency coefficient vector quantizer of claim 1, wherein the prediction structure quantizer and the non-prediction structure quantizer are connected in parallel to quantize the line spectral frequency coefficient vector.

3. The line spectral frequency coefficient vector quantizer of claim 1 or 2, wherein the first vector quantizer and the first lattice quantizer are connected in series to quantize the line spectral frequency coefficient vector.

4. The line spectral frequency coefficient vector quantizer of claim 1 or 2, wherein the second vector quantizer and the second lattice quantizer are connected in series to quantize the line spectral frequency coefficient vector.

5. The line spectral frequency coefficient vector quantizer of claim 1, wherein the first lattice quantizer is a pyramid vector quantizer.

6. The line spectral frequency coefficient vector quantizer of claim 1, wherein the second lattice quantizer is a pyramid vector quantizer.
